(19) United States
(12) Patent Application Publication
(10) Pub. No.: US 2007/0074917 A1
(43) Pub. Date: Apr. 5, 2007

(54) Adjustable mount for controller of power driven wheelchair

(75) Inventors: Bruce A. Jaenke, Parma, OH (US); Damon Jurkiewicz, Lakewood, OH (US); Daniel C. Watson, North Royalton, OH (US); Danield J. Stothard, North Olmsted, OH (US)

Correspondence Address: CALFEE HALTER & GRISWOLD, LLP, 800 SUPERIOR AVENUE, SUITE 1400, CLEVELAND, OH, 44114, US

(73) Assignee: Invacare Corp.

(21) Appl. No.: 11/513,780

(22) Filed: Aug. 31, 2006

Related U.S. Application Data
(60) Provisional application No. 60/712,987, filed on Aug. 31, 2005.
(60) Provisional application No. 60/726,993, filed on Oct. 15, 2005.

(51) Int. Cl. B60K 1/00

(52) U.S. Cl. 180/65.1

(57) ABSTRACT

An adjustable mount is provided that securely mounts a device to a power driven wheelchair, wherein the device is easily rotated, for example, to achieve a better viewing angle, improved access to the device, etc. Furthermore, the adjustable mount is operable to mount a variety of devices to a wheelchair, such as joysticks, other controller types, drink cups, etc.

### RELATED APPLICATION

The present application is being filed as a non-provisional patent application claiming priority under 35 U.S.C. § 119(e) from, and any other benefit of, U.S. Provisional Patent Application No. 60/712,987 entitled System And Method For Controlling A Wheelchair and filed on Aug. 31, 2005 (Attorney Docket No. 12873.05174); and U.S. Provisional Patent Application No. 60/726,993 entitled Adjustable Mount For Controller Of Power Driven Wheelchair and filed on Oct. 15, 2005 (Attorney Docket No. 12873.05247), which is hereby incorporated by reference.

### BACKGROUND

It is well known that physically impaired individuals with such disabilities as spinal cord injury, muscular dystrophy, multiple sclerosis, cerebral palsy or arthritis need the assistance of a power driven wheelchair to be mobile. Power driven wheelchairs, which may be of the type manufactured by Invacare Corporation of Elyria, Ohio, for example, generally include right and left side drive wheels driven by a motor controller via respectively corresponding right and left side drive motors, all of which are disposed on the wheelchair. A user can control, for example, the speed and direction of movement of the wheelchair, by manipulating a controller. A joystick is one common type of controller used with power driven wheelchairs. Another device that is commonly used with power driven wheelchairs is a display device. The display device itself may function as the controller (e.g., via an interactive display screen), or the display device may display data (e.g., interactive menus) that the user can interact with using the controller.

Typically, the controller and/or the display device is mounted to the wheelchair via a special mounting assembly. As one example, a “joystick tube” is secured to the armrest of the wheelchair and runs parallel to the armrest. A joystick clamp attaches to the joystick tube, such that a joystick is mounted to the wheelchair via the joystick clamp. Often, the orientation of the controller and/or display cannot be adjusted because of the structure of the mounting assembly.

### SUMMARY

Accordingly, it is an exemplary aspect to provide an adjustable mount for securely mounting a device to a power driven wheelchair.

It is another exemplary aspect to provide an adjustable mount for mounting a device to a power driven wheelchair, wherein the device is easy to attach to and remove from the mount.

It is yet another exemplary aspect to provide an adjustable mount for mounting a controller to a power driven wheelchair, wherein the controller is readily rotated within the mount.

It is another exemplary aspect to provide an adjustable mount for securely mounting a variety of devices to a power driven wheelchair.

### BRIEF DESCRIPTION OF THE DRAWINGS

The above aspects and additional aspects, features and advantages will become more apparent by describing in detail exemplary embodiments thereof with reference to the attached drawings, wherein like reference numerals denote like elements, and:

FIG. 1 is a top perspective view of a clamp assembly, according to an exemplary embodiment;

FIG. 2 is another top perspective view of the clamp assembly of FIG. 1;

FIG. 3 is a bottom perspective view of the clamp assembly of FIG. 1;

FIG. 4 is a bottom perspective view of a clamp of the clamp assembly of FIG. 1;

FIG. 5 is a bottom plan view of the clamp of the clamp assembly of FIG. 1;

FIG. 6 is a side perspective view of an exemplary joystick controller mounted to a joystick tube via the clamp assembly of FIG. 1;

FIG. 7 is a top view of the joystick controller of FIG. 6 mounted to the joystick tube via the clamp assembly of FIG. 1;

FIG. 8 is a bottom perspective view of the joystick controller of FIG. 6 mounted to the joystick tube via the clamp assembly of FIG. 1;

FIG. 9 is a bottom view of the joystick controller of FIG. 6 mounted to the joystick tube via the clamp assembly of FIG. 1;

FIG. 10 is a photographic view of an exemplary implementation of the clamp assembly of FIG. 1 mounted to a tube attached to a wheelchair;

FIG. 11 is a top perspective view of a clamp assembly, according to another exemplary embodiment;

FIG. 12 is a bottom perspective view of a clamp of the clamp assembly of FIG. 11;

FIG. 13 is a top perspective view of a clamp of a clamp assembly, according to yet another exemplary embodiment;

FIG. 14 is a top plan view of the exemplary clamp assembly of FIG. 11;

FIG. 15 is a top perspective view of an exemplary display device held by the clamp assembly of FIG. 11;

FIG. 16 is a bottom perspective view of the display device of FIG. 15 held by the clamp assembly of FIG. 11;

FIG. 17 is a side elevational view of the display device of FIG. 15 held by the clamp assembly of FIG. 11;

FIG. 18 is a photographic view of an exemplary implementation of the clamp assembly of FIG. 11 mounted to an arm extending from a wheelchair;

FIG. 19 is a photographic view of the exemplary implementation of the clamp assembly of FIG. 11 mounted to the arm, as viewed from another angle;

FIG. 20 is a diagram illustrating an exemplary joystick controller being mounted to an exemplary swingaway joystick chair attachment element via the clamp of the clamp assembly of FIG. 11;

FIG. 21 is a perspective view of a clamp of a clamp assembly, according to still another exemplary embodiment;

FIG. 22 is a perspective view of a plate for use with the clamp of FIG. 21; and

FIG. 23 is an exploded perspective view of an exemplary clamp assembly using the clamp of FIG. 21, prior to mounting.

### DETAILED DESCRIPTION OF EXEMPLARY EMBODIMENTS

Clamps and clamp assemblies are provided for mounting devices, such as joystick controllers, display devices, etc., to a power driven wheelchair, wherein the devices can be readily rotated with respect to the clamps and clamp assemblies, as disclosed herein.

An exemplary clamp has first and second portions, such as adjacent regions on the clamp. The first portion has a generally circular opening for accepting a generally circular projection (referred to herein as a “hub”) of a user control device. One part of the first portion can be moved with respect to another part of the first portion to secure the hub in the generally circular opening. The second portion, which may be integral with, or affixed to the first portion, attaches to a wheelchair or a structure extending from a wheelchair. The second portion may have a recess to facilitate attaching the clamp to a tube. In the alternative, the second portion can be configured to accept a pivot ball secured to the second portion via a plate.

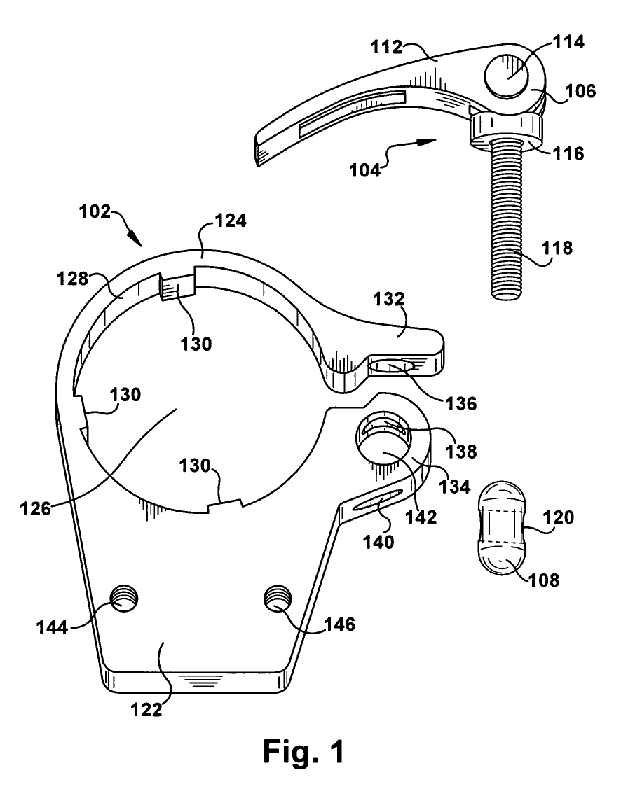

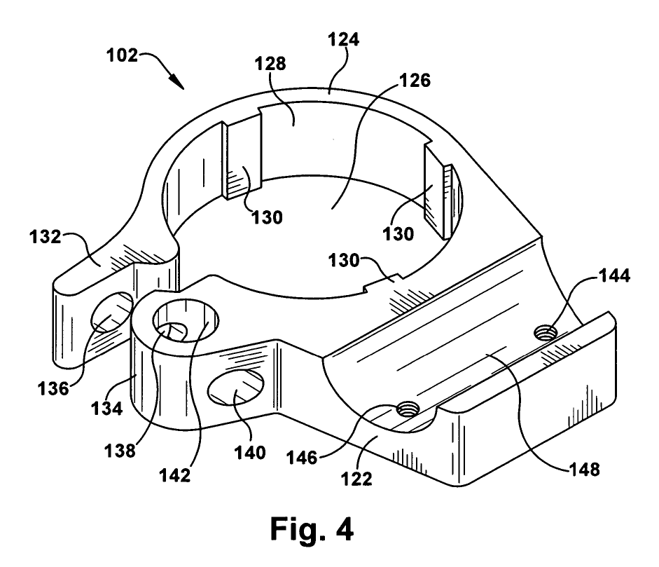

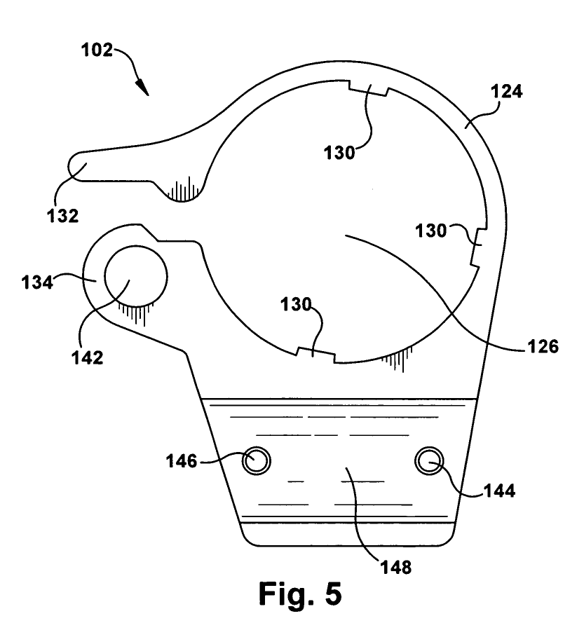

A clamp assembly for mounting a device to a wheelchair, according to an exemplary embodiment, is illustrated in FIGS. 1-5.

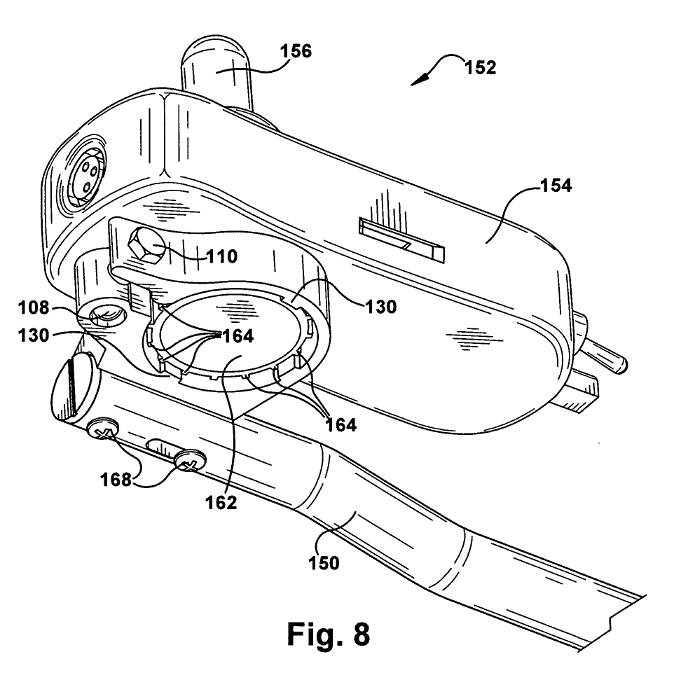

Referring now to FIG. 1, the exemplary clamp assembly 100 includes a clamp 102 and a device for tightening the clamp 102. As shown in FIG. 1, an exemplary device 104 for tightening the clamp 102 includes a cam element 106 and a nut 108. It will be appreciated that any device for adjusting and locking a tightness of the clamp 102 could be used, such as a bolt 110 (FIGS. 8-10) and the nut 108. The bolt 110 could have a socket head, a hex head, etc., which requires a tool to adjust. Other fasteners may be used to adjust the clamp 102.

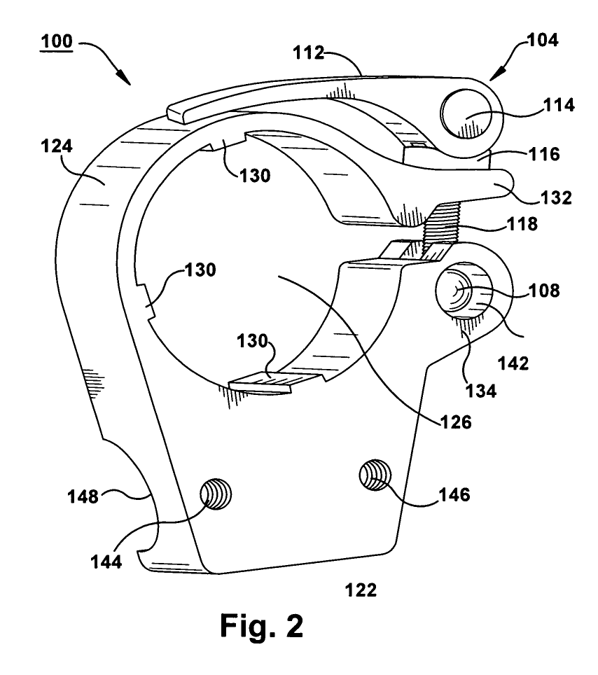

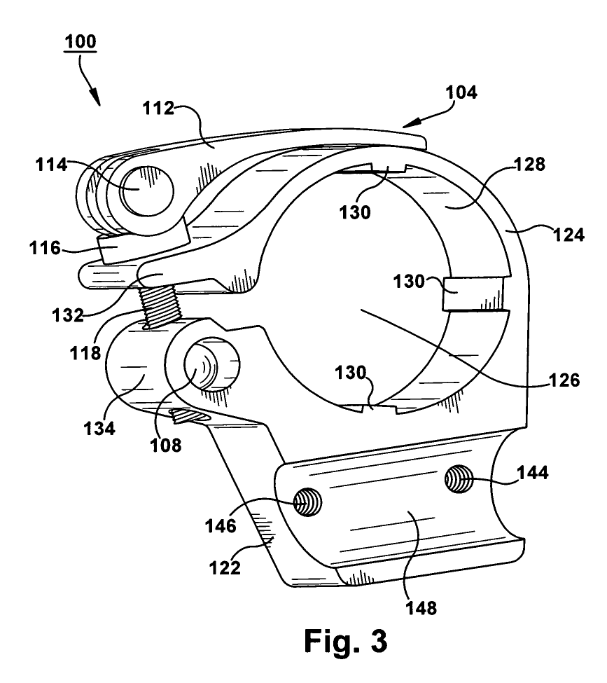

As shown in FIGS. 1-3, the exemplary cam element 106 includes a lever arm 112, a pin 114, a base 116 and a threaded shaft 118. The threaded shaft 118 of the cam element 106 can be screwed into a threaded through-hole 120 of the nut 108. The lever arm 112 pivots with respect to the base 116 via the pin 114. When the lever arm 112 is in a first position (i.e., an opened position), there is little tension between the base 116 and the nut 108. Conversely, when the lever arm 112 is in a second position (i.e., a closed position), as shown for example in FIGS. 2-3, there is increased tension between the base 116 and the nut 108.

Furthermore, when the lever arm 112 is in the first (opened) position, the lever can be rotated (e.g., clockwise) to cause the threaded shaft 118 to move further into the through-hole 120 of the nut 108, thereby decreasing the distance between the base 116 and the nut 108. This serves to increase the force acting on the nut 108 when the lever arm 112 is in the second (closed) position. If the lever arm 112 is rotated in the other direction (e.g., counterclockwise), the threaded shaft 118 backs out of the through-hole 120 of the nut 108, thereby increasing the distance between the base 116 and the nut 108. This serves to decrease the force acting on the nut 108 when the lever arm 112 is in the second (closed) position.

Accordingly, the cam element 106 and the nut 108 provide a device for varying the amount of force used to tighten the clamp 102, and for applying the force, without the need for any additional tools.

The clamp 102 itself includes an offset portion 122 and a clamping portion 124. The clamping portion 124 includes a generally circular opening 126 that forms an inner circumference 128 of the clamping portion 124. Preferably, but not necessarily, one or more protrusions 130 are located along the inner circumference 128 of the clamping portion 124. The height of the protrusions 130 may correspond to the thickness of the clamp 102.

The clamping portion 124 further includes a first clamp end (jaw) 132 at one end and a second clamp end (jaw) 134 at the other end, such that the first clamp end 132 and the second clamp end 134 are positioned across from one another. The first clamp end 132 and the second clamp end 134 may have complementary shapes, e.g., engaging or mating surfaces.

The first clamp end 132 includes a horizontal (i.e., having an axis that is perpendicular to the axis running through the center of the circular opening 126) through-hole 136. The second clamp end 134 includes a pair of horizontal through-holes 138, 140, which are aligned with the horizontal through-hole 136, and a vertical (i.e., having an axis that is parallel to the axis running through the center of the circular opening 126) through-hole 142. The nut 108 can be inserted in the vertical through-hole 142, such that an axis of the threaded through-hole 120 of the nut 108 is aligned with an axis of the horizontal through-holes 136, 138 and 140.

As shown in FIGS. 2 and 3, the threaded shaft 118 of the cam element 106 can be threaded through the threaded through-hole 120 of the nut 108 inserted in the vertical through-hole 142, by way of the horizontal through-holes 136, 138 and 140. In this manner, the cam element 106 and the nut 108 form a device for tightening the clamp 102 by reducing the size of the opening 126.

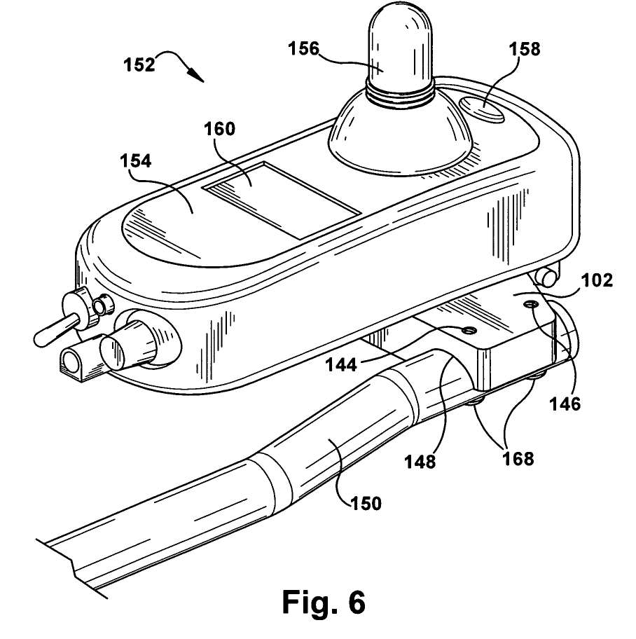

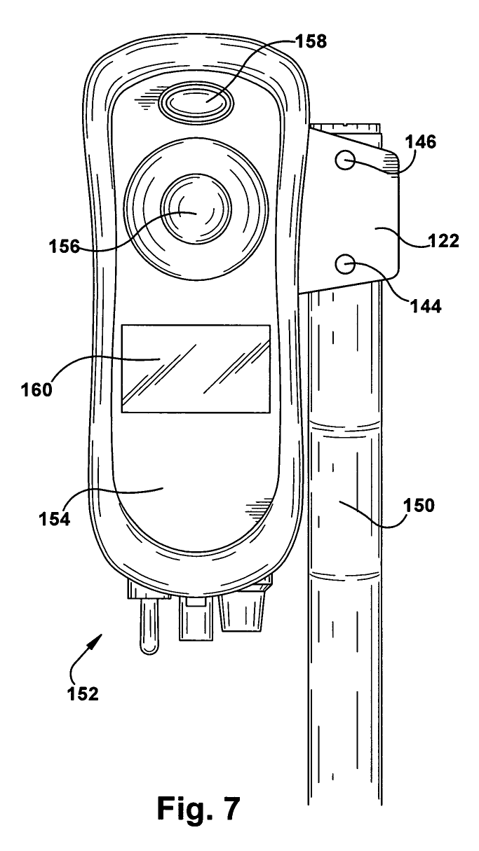

As shown in FIGS. 1-5, the offset portion 122 of the clamp 102 includes mounting holes 144, 146. These mounting holes 144, 146 may be (partially or fully) threaded. Additionally, as shown in FIGS. 2-5, the offset portion 122 also includes a curved recess portion 148 on one side of the clamp 102. Preferably, but not necessarily, the curvature of the curved recess portion 148 corresponds to a mounting surface, for example, a joystick tube 150 (FIGS. 6-10).

The clamping portion 124 of the clamp 102 functions as a clamping element, while the offset portion 122 of the clamp 102 functions as an attaching element. In an exemplary embodiment, the clamping portion 124 of the clamp 102 holds a joystick controller 152, while the offset portion 122 of the clamp 102 is mounted to a joystick tube 150, as shown in FIGS. 6-9.

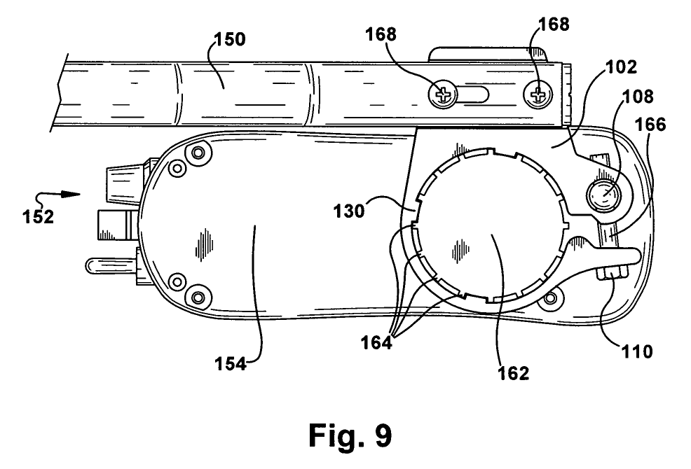

Referring to FIG. 6, the exemplary joystick controller 152 includes a housing 154, a joystick 156, a pushbutton 158 and a display screen 160 (e.g., an LCD screen). In FIGS. 8 and 9, it can be seen that the exemplary joystick controller 152 also includes a hub 162 connected to (or formed with) a bottom side of the housing 154. Preferably, but not necessarily, the exemplary hub 162 includes a plurality of ribs 164 positioned lengthwise along an outer circumference of the hub 162.

Preferably, but not necessarily, the ribs 164 are equally spaced around the outer circumference of the hub 162. Preferably, but not necessarily, the space between two adjacent ribs 164 is substantially the same as the width of a protrusion 130. The ribs 164 and the protrusions 130 provide predetermined locking/mounting positions, for example, in 11-12 degree increments. Of course, the amount of this increment can be readily varied by, for example, modifying the number of ribs, the spacing between the ribs, etc.

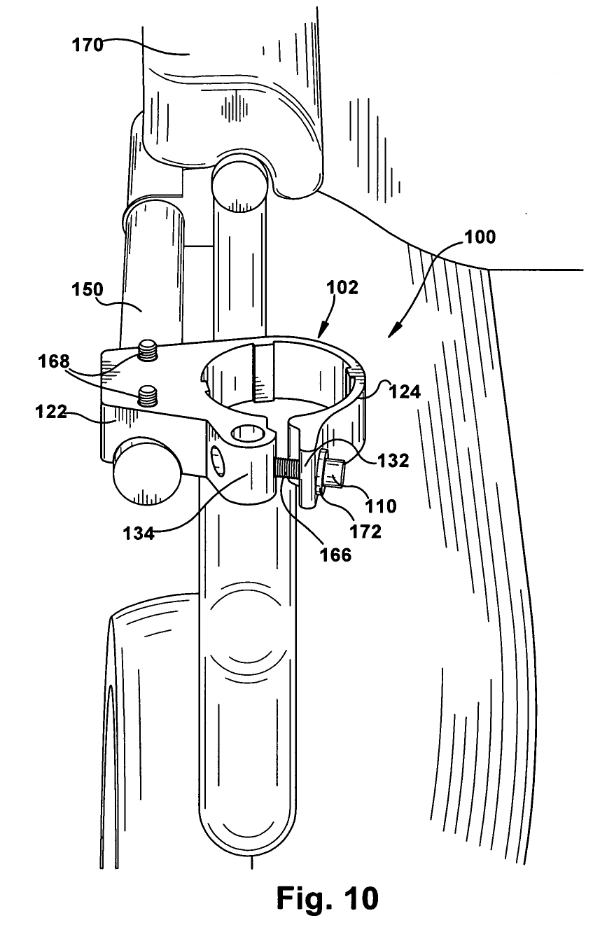

By disengaging, loosening or otherwise using a device for tightening the clamp 102 (e.g., the bolt 110 including a shaft 166 (FIGS. 9 and 10) having threads for meshing with the threaded through-hole 120 of the nut 108) to loosen the clamp 102, the size of the generally circular opening 126 of the clamping portion 124 is increased. Accordingly, the hub 162 of the joystick controller 152 (or other device to be held by the clamp 102) is easily inserted into (or repositioned within) the generally circular opening 126. Thereafter, by engaging, tightening or otherwise using the device for tightening the clamp 102 to tighten the clamp 102, the size of the generally circular opening 126 of the clamping portion 124 is decreased. As a result, the inner circumference 128 of the clamping portion 124 exerts force on the hub 162 or the ribs 164 of the hub 162. This force ensures the joystick controller 152 is securely held by the clamp 102. Other means for securing the hub 162 of the joystick controller 152 in the clamp 102 include set screws, a bayonet connection, interlocking surfaces, friction fitting, etc.

Once the clamp 102 is tightened around the hub 162 of the joystick controller 152, the clamping force prevents, for example, the joystick controller 152 from sliding out of the clamp 102 or rotating within the clamp 102. The protrusions 130 of the clamp 102 further secure the joystick controller 152 against any inadvertent rotation within the clamp 102. In particular, as shown in FIGS. 8 and 9, the protrusions 130 prevent rotation of the hub 162 in either direction by blocking movement of the ribs 164.

In another exemplary embodiment, the protrusions 130 align between the ribs 164 to prevent rotation of the hub 162 within the clamp 102, yet are sized so as to net exert any significant clamping force on the hub 162 or ribs 164. In still another exemplary embodiment, the clamp 102 has no protrusions 130 and the hub 162 has no ribs 164. In this case, the clamp 102 functions as a friction clamp for securing the hub 162, and the hub 162 enjoys full 360-degree rotatable positioning when the clamp 102 is loose.

As noted above, the offset portion 122 of the exemplary clamp 102 functions as an attaching element. Referring to FIGS. 6-9, the curved recess portion 148 of the exemplary offset portion 122 is positioned on the joystick tube 150, such that a pair of mounting screws 168 inserted through the joystick tube 150 enter mounting holes 144, 146 to affix the clamp 102 to the joystick tube 150. Accordingly, the joystick controller 152 held by the clamp 102 is mounted onto the joystick tube 150. Exemplary clamp 102 may be secured to a wheelchair frame in any suitable manner, directly or indirectly via any suitable coupling unit (e.g., joystick tube, swingaway element, etc.).

It should be noted that the clamp 102 is reversible in that the clamp 102 can be used (i.e., attached to the joystick tube 150) on both the left side and the right side of a wheelchair. Consequently, the clamp 102 could be used to mount the joystick controller 152 to either the left side or the right side of a wheelchair, depending on whether a user is left-handed or right-handed.

It will be appreciated that the clamp 102 can be attached to the joystick tube 150 with or without the joystick controller 152 (or other device) being held in the clamp 102. Similarly, the joystick controller 152 (or other device) may be inserted into the clamp 102 before or after the clamp 102 is attached to the joystick tube 150.

FIG. 10 is a photographic view of an exemplary implementation of the clamp assembly 100, according to one exemplary embodiment, mounted to a wheelchair. In FIG. 10, the joystick tube 150 is attached to the wheelchair, so as to extend parallel to an armrest 170 of the wheelchair. It will be appreciated that other chair attaching elements may be used instead of the joystick tube 150. The clamp assembly 100 includes the clamp 102 and a device for tightening the clamp 102. An exemplary device for tightening the clamp 102 may include the bolt 110, a washer 172, the threaded shaft 166 and the nut 108, as shown in FIG. 10. The device for tightening the clamp 102 operates to force the first clamp end 132 and the second clamp end 134 toward one another.

The clamp assembly 100 is attached to the joystick tube 150 by a pair of mounting screws 168 extending through the offset portion 122 of the clamp 102. It is generally desirable for a hand-operated device (e.g., joystick controller 152) to be in line with the armrest 170 of the wheelchair to facilitate good positioning of the user's hand with respect to the device. The offset portion 122 of the clamp 102 brings the clamping portion 124 of the clamp 102 substantially in line with the armrest 170 of the wheelchair so that when a device is mounted in the clamp 102, the device will be substantially in line with the armrest 170 of the wheelchair.

Variations in the size of the offset portion 122 of the clamp are within the spirit and scope of the general inventive concept. For example, depending on the type of wheelchair, the type of chair mounting element (e.g., the type of joystick tube), the type of armrests, etc., a differently sized and/or shaped offset portion 122 may be used.

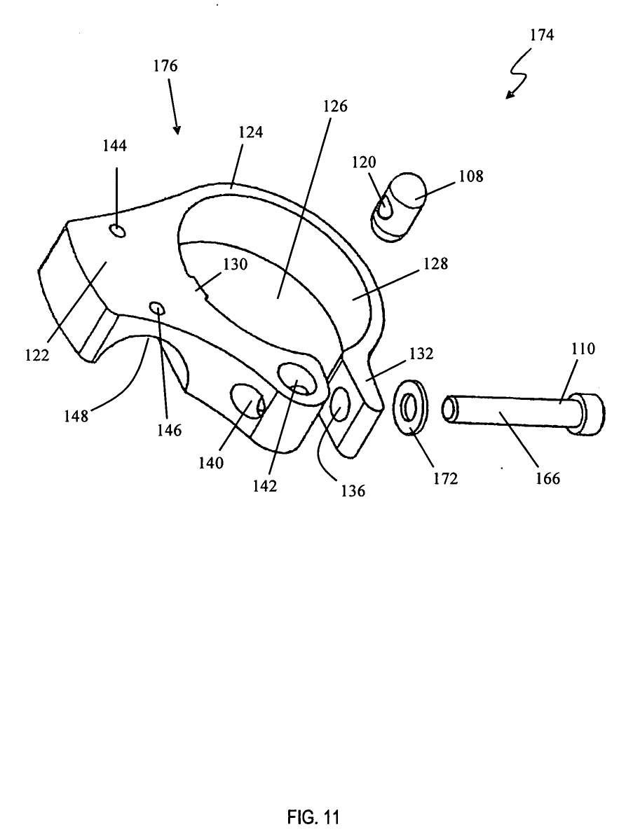

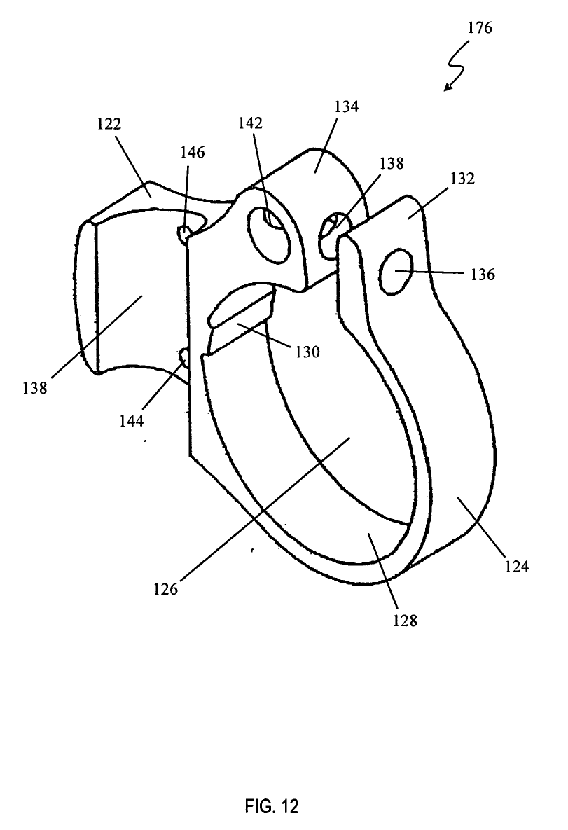

A clamp assembly for mounting a device to a wheelchair, according to another exemplary embodiment, is illustrated in FIGS. 11-12.

Referring to FIGS. 11 and 12, the exemplary clamp assembly 174 includes a clamp 176 that differs from the above-described clamp 102 by having a single protrusion 130. The protrusion 130 interfaces with the ribs 164 on the hub 162 of a device (e.g., joystick controller 152) to be mounted on a wheelchair.

Additionally, the exemplary clamp 176 of the exemplary clamp assembly 174 is tightened around the hub 162 of the device by the bolt 110 or similar structure that requires a tool to adjust. Furthermore, the tool may be a specialized tool (e.g., a hex wrench). In this manner, unlike the exemplary embodiment of FIGS. 1-10, a user of the wheelchair is prevented from readily loosening the clamp 176 after a device is installed in the clamp 176, for example, by a provider of the device and/or wheelchair.

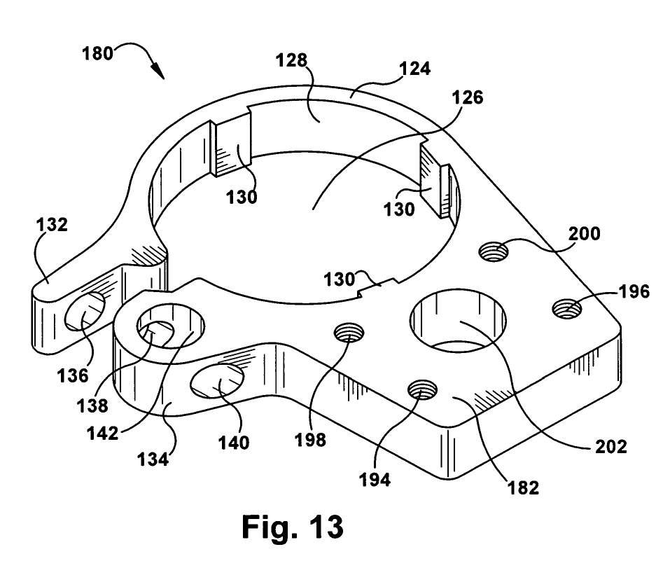

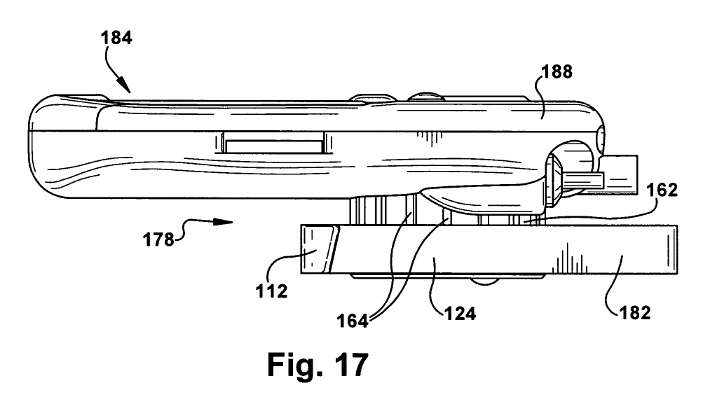

A clamp assembly for mounting a device to a wheelchair, according to yet another exemplary embodiment, is illustrated in FIGS. 13-17.

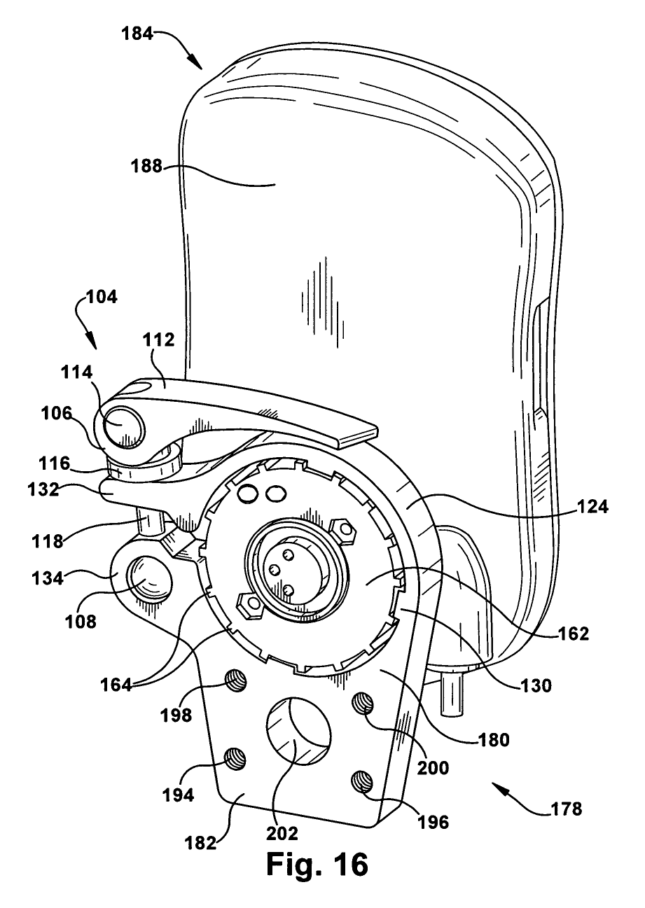

With reference to FIGS. 13-17, the exemplary clamp assembly 178 includes an exemplary clamp 180 and an exemplary device for tightening the clamp 180. It will be appreciated that the same device 104 (FIGS. 1-3) used for tightening clamp 102 or the bolt 110 used for tightening clamp 176 (FIGS. 11-12) could be used for tightening the clamp 180. For example, as shown in FIG. 16, the device for tightening the clamp 180 may be the cam element 106, which includes the lever arm 112, the pin 114, the base 116 and the threaded shaft 118, and the nut 108. The clamp 180 includes horizontal through-holes 136, 138 and 140 and vertical through-hole 142 for receiving such a device.

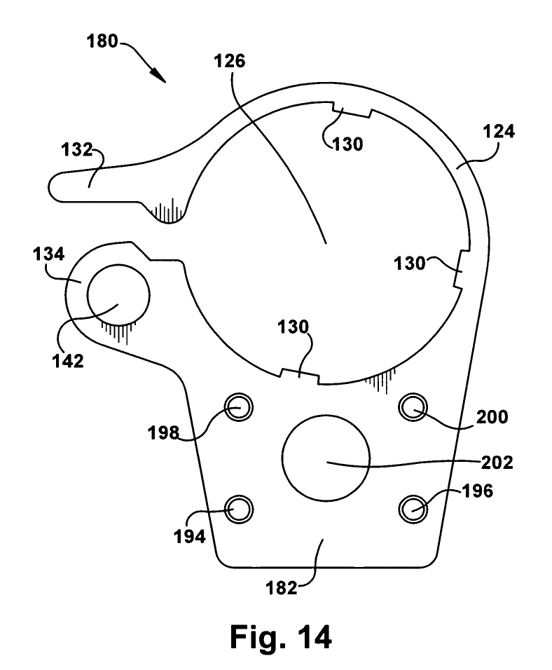

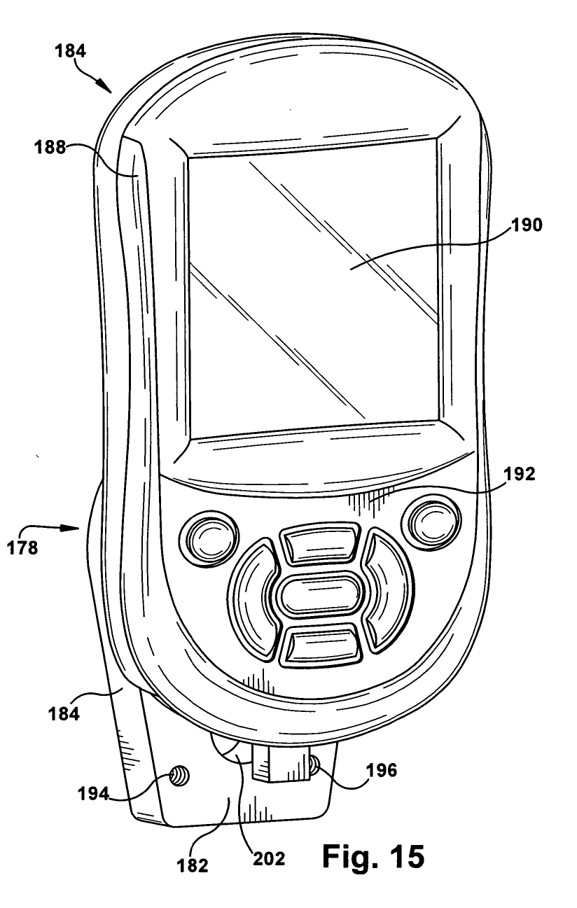

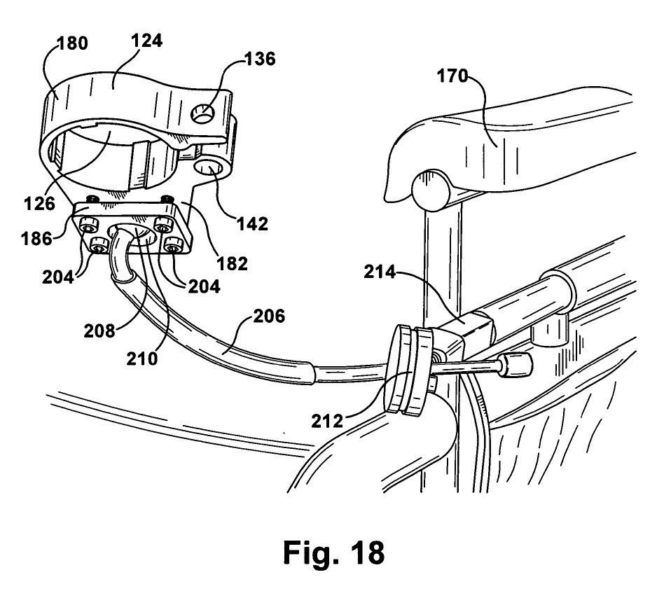

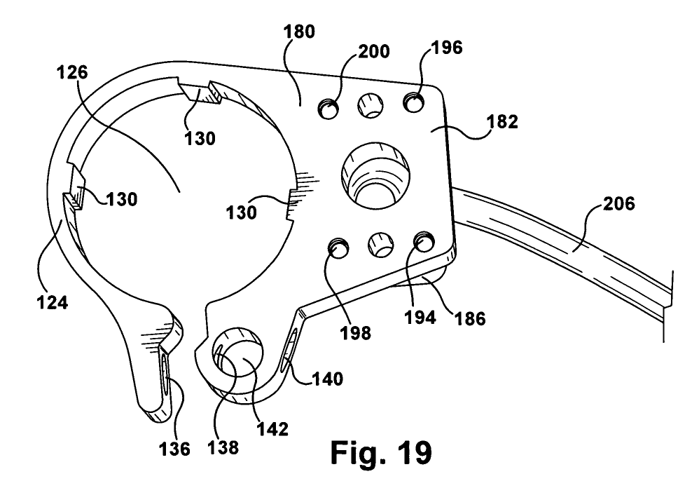

Referring to FIGS. 13-14, the clamp 180 is identical to the clamp 102 shown in FIGS. 1-5 and discussed above, except for changes in offset portion 182 vis-a-vis offset portion 122. The clamp 180 includes an offset portion 182 and a clamping portion 124. The clamping portion 124 of the clamp 180 functions as a clamping element, while the offset portion 182 of the clamp 180 functions as an attaching element, as discussed above in connection with clamp 102. As one example, the clamping portion 124 of the clamp 180 holds a display device 184, as shown in FIGS. 15-17, while the offset portion 182 of the clamp 180 is mounted to a plate 186, as shown in FIGS. 18-19.

Referring to FIGS. 15-17, the exemplary display device 184 includes, for example, a housing 188, a display screen 190 and pushbuttons 192. The display device 184 also includes a hub 162, which may include a plurality of ribs 164 disposed thereon. The hub 162 of the display device 184 can be inserted into the clamp 180, as described above. Accordingly, the display device 184 can be rotated and then securely held by the clamp 180.

The clamp 180 and the clamp 102 differ mainly in the way that they attach to a wheelchair, resulting in a few structural differences between the clamp 180 and the clamp 102. In particular, while the clamping portion 124 of the clamp 180 is substantially the same as the clamping portion 124 of the clamp 102, the offset portion 182 of the clamp 180 differs from the offset portion 122 of the clamp 102. For example, the offset portion 182 of the clamp 180 includes four mounting holes 194, 196, 198 and 200. One or more of the mounting holes 194, 196, 198 and 200 may be (partially or fully) threaded. Additionally, the offset portion 182 of the clamp 180 includes a circular opening 202. Preferably, but not necessarily, the offset portion 182 of the clamp 180 lacks the curved recess portion 148 of the clamp 102, which may be used to secure clamp 102 to a wheelchair member, as described above.

According to an exemplary embodiment, the clamp 180 is mounted to the plate 186, for example, by four mounting screws 204 screwed into mounting holes 194, 196, 198 and 200, respectively, as shown in FIGS. 18 and 19. Referring to FIGS. 18 and 19, an arm 206 (e.g., a rigid or flexible rod), having a ball 208 on one end, is provided. The plate 186 may have a non-planar portion (not shown) that engages the ball 208. This non-planar portion may be, for example, a section of a sphere, or a section of a cone, or approximately a section of a sphere or a cone. The portion 182 may have a similar non-planar portion (not shown) that engages the ball 208. It will be appreciated that the ball 208 may be affixed to devices other than the arm 206.

Before the clamp 180 is mounted to the plate 186, the arm 206 is fed through a circular opening 210 of the plate 186. Because the ball 208 is wider than the diameter of the circular opening 210, the ball 208 does not pass through the circular opening 210. The other end of the arm 206 (i.e., the end without the ball) may be connected to a connector assembly 212, which in turn is connected to an arm mounting assembly 214.

After the arm 206 is fed through the circular opening 210 of the plate 186, the clamp 180 is mounted to the plate 186. Consequently, the ball 208 is caught between the clamp 180 (including the circular opening 202) and the plate 186 (including the circular opening 210). As a result, the clamp 180 may be freely rotated about the ball 208. When a device (e.g., display device 184) is to be mounted in the clamp 180, the device is adjustable by rotating the orientation of the device (i.e., its hub 162) and/or pivoting the clamp about the ball 208, providing increased adjustability.

Certain devices may require or benefit from this increased adjustability. For example, a display device (e.g., display device 184) typically requires more positioning options to place it in view of a user, while a joystick controller (e.g., joystick controller 152) typically requires less adjustability. However, various devices having substantially similar hubs 162 are interchangeably mountable to a clamp or clamps (e.g., clamps 180 and 102).

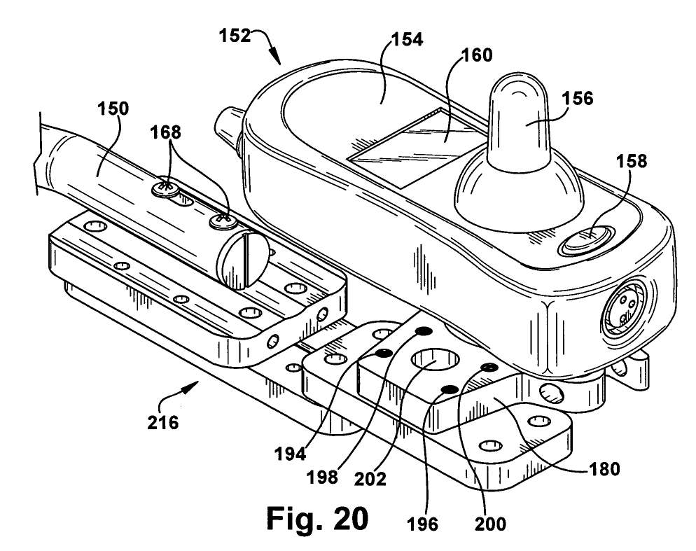

As an example, either of the joystick controller 152 and the display device 184 could be held by the clamp 180 illustrated in FIGS. 18 and 19. Additionally, the clamps 180 and 102 can be easily installed onto other chair attachment elements. FIG. 20 shows a joystick controller being mounted to a swingaway joystick chair attachment element.

Referring to FIG. 20, the joystick controller 152 is mounted to the swingaway joystick chair attachment element 216 via clamp 180. The swingaway joystick chair attachment element is attached to the wheelchair via a joystick tube 150.

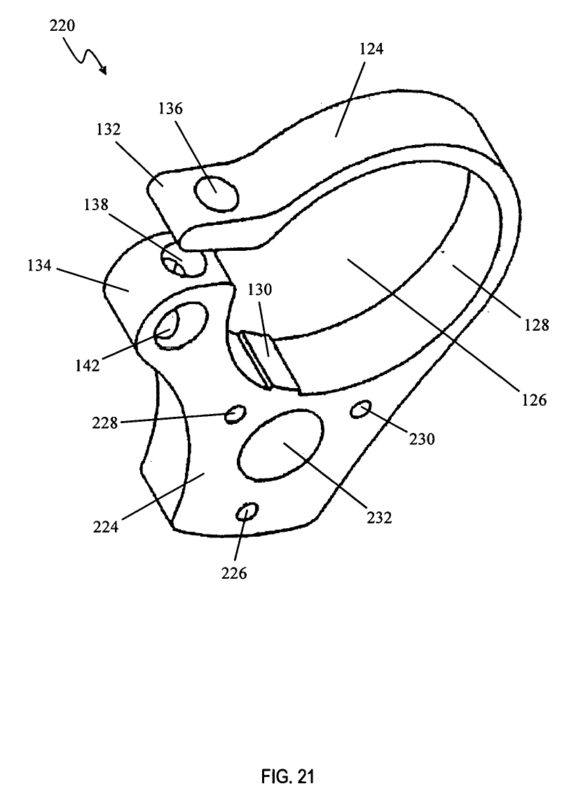

A clamp assembly for mounting a device to a wheelchair, according to still another exemplary embodiment, is illustrated in FIGS. 21-23.

As shown in FIGS. 21-23, the exemplary clamp assembly 218 includes an exemplary clamp 220, an exemplary device for tightening the clamp 220 and an exemplary plate 222. The clamp 220 includes an offset portion 224 and a clamping portion 124. The clamping portion 124 of the clamp 220 functions as a clamping element, while the offset portion 224 of the clamp 220 functions as an attaching element, as discussed above in connection with clamp 180. In this exemplary embodiment, the offset portion 224 of the clamp 220 includes three mounting holes 226, 228 and 230. One or more of the mounting holes 226, 228 and 230 may be (partially or fully) threaded. Additionally, the offset portion 224 of the clamp 220 includes a circular opening 232.

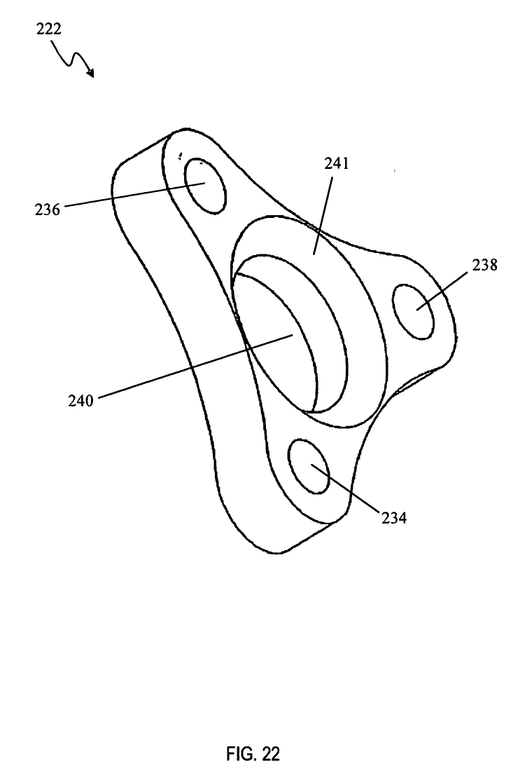

As shown in FIG. 22, the plate 222 includes three mounting holes 234, 236 and 238, which can be substantially aligned with the mounting holes 226, 228 and 230 of the clamp 220. Preferably, but not necessarily, the plate 222 is symmetrical, such that each of its mounting holes 234, 236 and 238 may be aligned with any of the mounting holes 226, 228 and 230 of the clamp 220. The plate 222 also includes a circular opening 240, which can be substantially aligned with the circular opening 232 of the clamp 220. The plate 186 may have a non-planar portion 241 that engages the ball 208. This non-planar portion 241 may be, for example, a section of a sphere, or a section of a cone, or approximately a section of a sphere or a cone. The portion 224 may have a similar non-planar portion (not shown) that engages the ball 208. It will be appreciated that the ball 208 may be affixed to devices other than the arm 206.

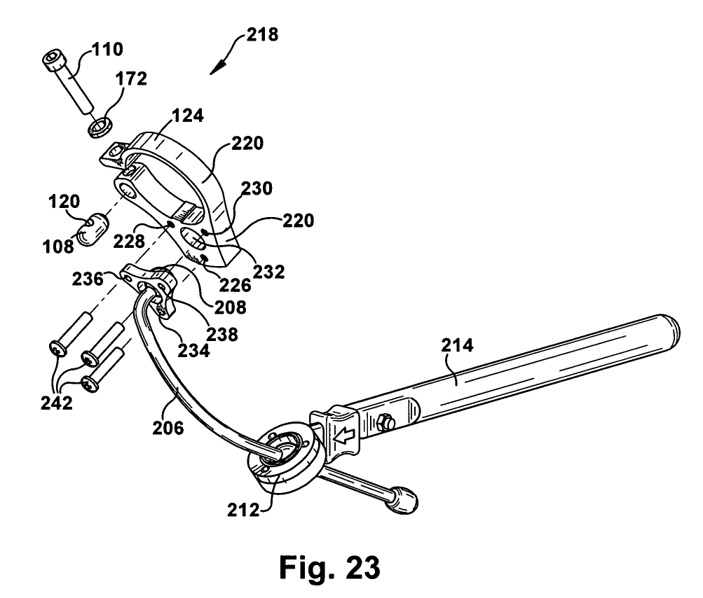

According to one exemplary embodiment, the clamp 220 is mounted to the plate 222, for example, by three mounting screws 242 screwed through mounting holes 234, 236 and 238 of the plate 222 and mounting holes 226, 228 and 230 of the clamp 220. Referring to FIG. 23, the arm 206 (e.g., a rigid or flexible rod), having the ball 208 on one end, is provided. It will be appreciated that the ball 208 may be affixed to devices other than the arm 206.

Before the clamp 220 is mounted to the plate 222, the arm 206 is fed through the circular opening 240 of the plate 222. Because the ball 208 is wider than the diameter of the circular opening 240, the ball 208 does not pass through the circular opening 240. The other end of the arm 206 (i.e., the end without the ball) may be connected to a connector assembly 212, which in turn is connected to an arm mounting assembly 214.

After the arm 206 is fed through the circular opening 240 of the plate 222, the clamp 220 is mounted to the plate 222. Consequently, the ball 208 is caught between the clamp 220 (including the circular opening 232) and the plate 222 (including the circular opening 240). As a result, the clamp 220 may be freely rotated about the ball 208. The degree of freedom with which the clamp 220 may be rotated about the ball 208 may be controlled, in part, by tightening or loosening the fasteners (e.g., mounting screws 242). When a device (e.g., display device 184) is to be mounted in the clamp 220, the device is adjustable by rotating the orientation of the device (i.e., its hub 162) and/or pivoting the clamp about the ball 208, providing increased adjustability.

In view of the above, an adjustable mount is provided that securely mounts a device to a power driven wheelchair, wherein the device is easily rotated during mounting, for example, to achieve a better viewing angle, improved access to the device, etc. Furthermore, the adjustable mount is operable to mount a variety of devices to a wheelchair, such as joysticks, other controller types, drink cups, cup holders, etc. The adjustable mount may be scaled up or down to accommodate these and other devices.

Exemplary embodiments have been provided herein for purposes of illustration and are not intended to in any way be limiting. Indeed, additional advantages and modifications will readily appear to those skilled in the art. For example, variations in the size and shape of the clamp can be made. Accordingly, such departures may be made from the exemplary embodiments without departing from the spirit or scope of the general inventive concept.

We claim:

1. An apparatus for mounting a device to a wheelchair, the apparatus comprising:
a clamp having an opening for receiving a projection extending from the device; and
an adjusting element for changing the size of the opening to retain the projection in the opening; and
wherein the clamp is operable to receive the projection in any of a plurality of different orientations.

2. The apparatus of claim 1, wherein the clamp has a first jaw and a second jaw disposed opposite one another, and
wherein the adjusting element changes the size of the opening by varying the distance between the first jaw and the second jaw.

3. The apparatus of claim 1, wherein the clamp includes one or more mounting holes for attaching the clamp to the wheelchair.

4. The apparatus of claim 1, wherein a mount is attached to the wheelchair and the clamp is attached to the mount.

5. The apparatus of claim 1, wherein each orientation of the plurality of orientations comprises a discrete position and the discrete positions are equally spaced by a predetermined angle.

6. The apparatus of claim 1, wherein the plurality of orientations range from 0 to 360 degrees.

7. The apparatus of claim 1, wherein an inner portion of the clamp defining the opening includes at least one protrusion;
wherein a plurality of ribs are formed on an outer periphery of the projection; and
wherein the at least one protrusion fits between an adjacent pair of the ribs when the clamp receives the projection.

8. An apparatus for mounting a device to a wheelchair, the apparatus comprising:
means for receiving a projection extending from the device in an opening; and
means for changing the size of the opening; and
wherein the opening is adapted to receive the projection in any of a plurality of different orientations.

9. A combination for mounting a device to a wheelchair, the combination comprising:
a substantially circular projection for attaching to the device;
a clamp having a substantially circular opening for receiving the projection; and
an adjusting element for changing the size of the opening; and
wherein the opening is adapted to receive the projection in any of a plurality of different orientations.

10. The combination of claim 9, wherein the projection is formed integrally with a housing of the device.

11. The combination of claim 9, wherein the clamp includes one or more mounting holes for attaching the clamp to the wheelchair.

12. The combination of claim 9, wherein a mount is attached to the wheelchair and the clamp is attached to the mount.

13. The combination of claim 9, wherein each orientation of the plurality of orientations comprises a discrete position and the discrete positions are equally spaced by a predetermined angle.

14. The combination of claim 9, wherein the plurality of orientations range from 0 to 360 degrees.

15. The combination of claim 9, wherein an inner portion of the clamp defining the opening includes at least one protrusion;
wherein a plurality of ribs are formed on an outer periphery of the projection; and
wherein the at least one protrusion fits between an adjacent pair of the ribs when the clamp receives the projection.

16. The combination of claim 9, wherein the projection is rotatable within the clamp when the opening of the clamp is a first size; and
wherein the projection is fixed within the clamp when the opening of the clamp is a second size.

17. The combination of claim 9, further comprising a wheelchair, and wherein the clamp is mounted to the wheelchair.

18. A clamp assembly for mounting a device to a wheelchair, the clamp assembly comprising:
a clamp having a clamping portion and an attaching portion; and
wherein the clamping portion defines a substantially circular opening extending from a first clamp end to a second clamp end;
wherein the first clamp end and the second clamp end are substantially adjacent;
wherein the first clamp end includes at least one first through hole;
wherein the second clamp end includes at least one second through hole;
wherein the at least one first through hole and the at least one second through hole are substantially aligned;
wherein the attaching portion includes at least one mounting hole.

19. The clamp assembly of claim 18, wherein adjacent sides of the first clamp end and the second clamp end have complementary shapes.

20. The clamp assembly of claim 18, further comprising an adjusting assembly for changing the size of the opening by varying the distance between the first clamp end and the second clamp end; and
wherein the adjusting assembly includes a threaded fastener having at least a portion that is threaded that extends through the at least one first through hole and the at least one second through hole and a nut having a threaded through hole for receiving the threaded fastener.

21. The clamp assembly of claim 20, wherein the adjusting element further comprises a cam assembly comprising a lever arm, a pin, a base and the threaded fastener;
wherein the base is disposed at an end of the threaded fastener;
wherein the pin is disposed above the base; and
wherein the lever arm is connected to the cam assembly via the pin and is operable to pivot about the pin.

22. The clamp assembly of claim 18, wherein at least one protrusion is formed on an inner portion of the circular opening.

23. The clamp assembly of claim 22, wherein a device to be mounted in the clamp assembly includes a substantially circular projection;
wherein a plurality of ribs are formed on an outer periphery of the projection; and
wherein the at least one protrusion fits between an adjacent pair of the ribs when the clamp receives the projection.

24. The clamp assembly of claim 18, wherein the attaching portion includes a plurality of the mounting holes and a circular opening.

25. The clamp assembly of claim 24, further comprising a clamp plate for connecting to the attaching portion of the clamp;
wherein the clamp plate includes a plurality of connecting holes and a circular opening;
wherein the connecting holes of the clamp plate are aligned with the mounting holes of the attaching portion when the clamp plate is connected to the attaching portion of the clamp;
wherein the circular opening of the clamp plate is aligned with the circular opening of the attaching portion when the clamp plate is connected to the attaching portion of the clamp; and
wherein a ball disposed at an end of a rod is held between the clamp plate and the attaching portion of the clamp when the clamp plate is connected to the attaching portion of the clamp so that the clamp assembly may pivot about the ball.

26. A wheelchair comprising at least two wheels carried by a frame, and a clamp assembly mounted on the wheelchair frame, the clamp assembly including:
a clamp having a substantially circular opening for receiving a substantially circular projection of a device to be secured in the clamp; and
an adjusting element for changing the size of the opening; and
wherein the opening is adapted to receive the projection in any of a plurality of different orientations.

27. The wheelchair of claim 26, wherein the wheelchair further comprises a motor for driving the two wheels of the wheelchair; and
wherein the device is a controller for controlling movement of the wheelchair.
